(19) United States
(12) Patent Application Publication
(10) Pub. No.: US 2019/0050391 A1
(43) Pub. Date: Feb. 14, 2019

(54) TEXT SUGGESTION BASED ON USER CONTEXT

(71) Applicant: Lenovo (Singapore) Pte. Ltd., Singapore (SG)

(72) Inventors: Jonathan Gaither Knox, Morrisville, NC (US); Russell Speight VanBlon, Raleigh, NC (US); Roderick Echols, Chapel Hill, NC (US); Ryan Charles Knudson, Durham, NC (US)

(21) Appl. No.: 15/673,044

(22) Filed: Aug. 9, 2017

(51) Int. Cl. G06F 17/27; G06F 3/023; H04L 12/58

(52) U.S. Cl. CPC G06F 17/276; H04L 51/046; H04L 51/20; G06F 3/0237

(57) ABSTRACT

One embodiment provides a method, including: receiving, from a user, user input comprising one or more characters; identifying, using a processor, a context associated with the user; and providing, using a processor, at least one text suggestion based upon the received one or more characters and the identified context. Other aspects are described and claimed.

### BACKGROUND

Many users use information handling devices (e.g., smart phones, mobile phones, tablets, personal computers, smart watches, etc.) to perform many different functions. Many of these functions include a user providing input to the device using one or more of a plurality of possible input modalities (e.g., mechanical key input, voice input, gesture input, etc.). For example, a user may input text in a text message to be sent to a contact of the user. As another example, a user may provide voice input to a note taking application which may be stored on the device. In order to make the applications more user friendly, the device or application may provide text suggestions while a user is providing input, for example, as text completion predictions, text correction suggestions, and the like.

### BRIEF SUMMARY

In summary, one aspect provides a method, comprising: receiving, from a user, user input comprising one or more characters; identifying, using a processor, a context associated with the user; and providing, using a processor, at least one text suggestion based upon the received one or more characters and the identified context.

Another aspect provides an information handling device, comprising: a processor; a memory device that stores instructions executable by the processor to: receive, from a user, user input comprising one or more characters; identify a context associated with the user; and provide at least one text suggestion based upon the received one or more characters and the identified context.

A further aspect provides a product, comprising: a storage device that stores code, the code being executable by a processor and comprising: code that receives, from a user, user input comprising one or more characters; code that identifies a context associated with the user; and code that provides at least one text suggestion based upon the received one or more characters and the identified context.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of providing a text suggestion based upon a context associated with a user.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Many information handling devices which capture or receive user input, display user input, or the like, provide applications or system level functions that can suggest corrections or suggestions for text input. For example, as a user is typing or providing text input, the application may provide suggestions for completion of the text input. As another example, if the system detects that a word or character string is incorrectly spelled, the system may provide suggestions for correcting the text input. In some cases the system automatically corrects the character string with the most likely text suggestion candidate. Such an automatic correction is also known as “auto-correct.” Typically to provide text suggestions, including corrections or predictions, the system accesses a language model. The standard language model is based upon the received user input. For example, if a user has entered the letters “sc” the language model prepopulates with “sc” and provides suggestions based upon words or character strings starting with “sc”.

In some cases, the text suggestion application may identify a context associated with the text input. For example, if a user is providing text input in the context of a sentence, the system may identify surrounding character strings and use grammar or language models that are based upon words commonly associated with each other. As another example, the system may access a user history to determine common character strings that the user provides. In this manner, the user can train the system to provide suggestions based upon words that the user prefers. As an example, if a user frequently uses the word “yinzers” the system may learn this word and when the user starts to provide the input “yi”, the word “yinzers” may be provided as a suggestion. However, the system does not take into account a context of the user. Rather, at best, the text suggestions are based upon a context of the text input, for example, the text suggestions may be based upon a history of the user, context of the surrounding character strings, an underlying application, and the like. However, the system does not identify a context of the user and then modify the text suggestions based upon the context of the user.

Accordingly, an embodiment provides a method of providing text suggestions not only based upon the received characters, but also based upon an identified context of the user. An embodiment may receive user input comprising one or more characters (e.g., symbols, letters, numbers, etc.). The user input may be received through a variety of input modalities, for example, voice input, gesture input, mechanical input (e.g., mechanical keyboard, soft keyboard, touch input, mouse input, etc.), and the like.

An embodiment may then identify a context associated with the user who provided the user input. The context of a user may include the location of the user, which may be an exact location, for example, a particular global positioning system (GPS) coordinate, a particular country or region, and the like, or may be an environment of the user, for example, basketball game, school, work, grocery store, and the like. In one embodiment the context of the user may include an activity of the user. For example, the context may include identifying the user is driving, the user is playing a sport, the user is shopping, the user is watching television, or the like. The context of the user may also include a reading level or comprehension level of the user. This context may also be associated with another person associated with the user. For example, if the user is texting another contact, an embodiment may determine the reading level or comprehension level of the contact rather than the user. The context associated with the user may then be identified as the reading level of the contact.

Once the context has been determined an embodiment may provide a text suggestion based, not only on the received user input, but also based upon the identified context of the user. The text suggestion may include a prediction associated with the text input, for example, a suggestion to complete the word. The text suggestion may also include a suggested correction. For example, an embodiment may determine that a word or character string was misspelled or cannot be identified and may then provide a suggestion for correcting the text input. Such a system may provide for text suggestions that are more closely related to what the user is actually attempting to provide.

The illustrated example embodiments will be best understood by reference to the figures. The following description is intended only by way of example, and simply illustrates certain example embodiments.

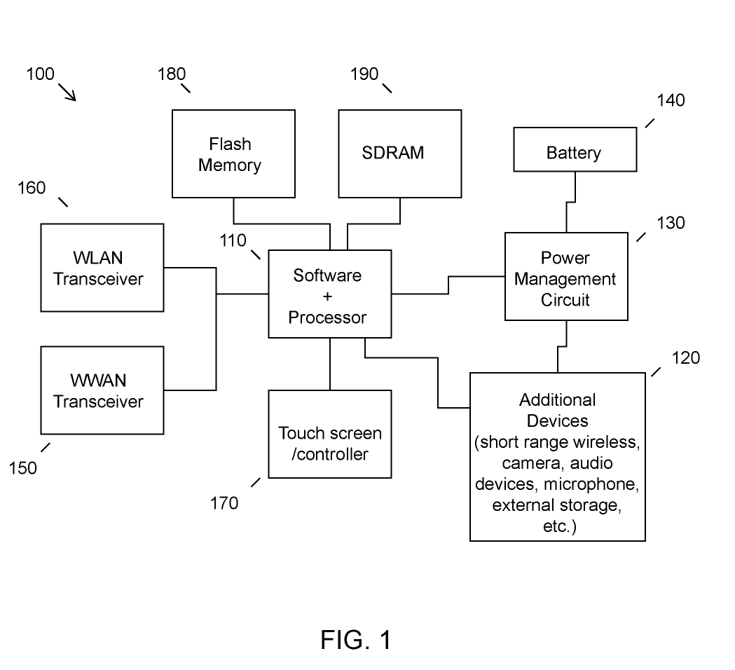

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

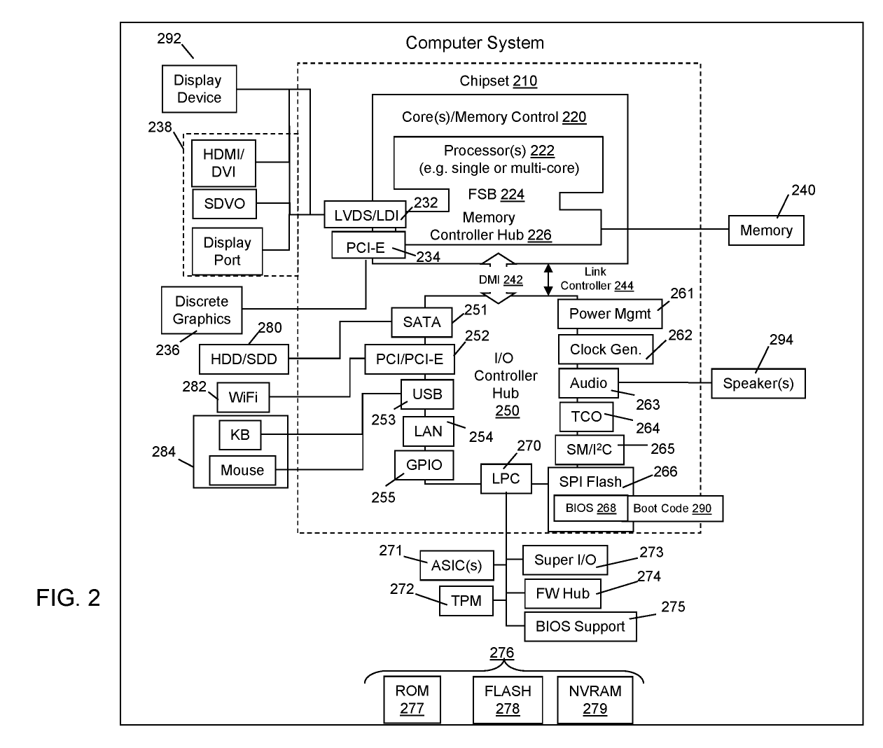

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which users may use to receive user input or perform functions associated with user input. For example, the circuitry outlined in FIG. 1 may be implemented in a tablet or smart phone embodiment, whereas the circuitry outlined in FIG. 2 may be implemented in a personal computer embodiment.

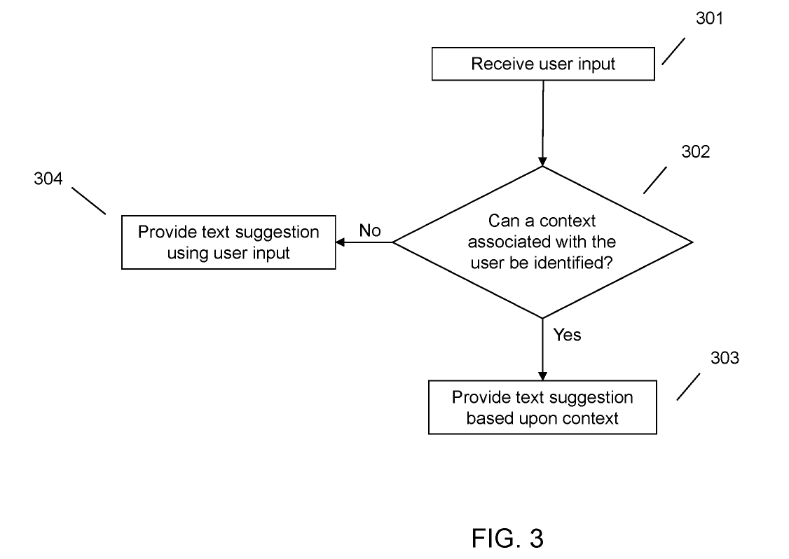

FIG. 3 illustrates a method for providing text suggestions based upon a context of the user. At 301 an embodiment may receive user input from a user. The user input may include one or more characters (e.g., symbols, letters, numbers, etc.). Not all the characters have to be the same type. For example, a user may provide a combination of symbols and letters in the same user input. The user input may include an entire or complete character string (e.g., a word, phrase, identifier, acronym, abbreviation, etc.). Alternatively, the user input may include a partial character string (e.g., start of a word, abbreviated character string that needs converted to a full character string, etc.).

In one embodiment the text input may be the direct input provided by the user, for example, a user may use a mechanical keyboard, soft keyboard, mouse, or the like, to select characters (e.g., letters, symbols, numbers, etc.) to form the text input. Alternatively, the direct input may include handwriting input that an embodiment converts to machine text. For example, a user may provide a handwriting input and an embodiment may use a variety of different ink stroke character recognition techniques to convert the handwriting input to machine text. This conversion to machine text does not necessarily mean that the handwriting input rendering is converted to machine text. Rather, an embodiment may run a background process that converts the handwriting input to machine input to be recognized by an embodiment. Additionally, the text input may include input received from a different input modality, for example, audio input, gesture input, and the like, which an embodiment converts to machine text either for recognition purposes or for display on a display device.

Receipt of the user input may be in conjunction with a particular application or function of the device. For example, a user may provide, using a mechanical input device, user input to be input to a text message to be sent to a contact of the user. As another example, a user may provide, using a voice recognition module, user input to a digital assistant for processing by the digital assistant. The digital assistant may then perform a function in connection with the user input. For example, the user may provide a request to the digital assistant to start a shopping list and then provide user input to compile the shopping list. As a final example, the user may provide, using a touch screen, handwriting input to a note taking application.

At 302 an embodiment may determine whether a context associated with the user can be identified. A context of the user may include any information related to the user which identifies a characteristic unique to the user. Context of a user may include, but is not limited to, a location of the user, an environment of the user, activity of the user, reading level or comprehension level of the user or person associated with the user, history of the user, region of the user, gender of the user, other people around the user, and the like. In one embodiment the context associated with the user may include a location or environment of the user. The location may be a particular location, for example, a particular grocery store, a particular school, a particular building, a GPS position of the user, and the like. Alternatively, the location may include a broader less specific location, for example, a country of the user, a region of the user, a general building which may have multiple stores or businesses, and the like. In one embodiment the context of the user may include a current activity of the user. For example, an embodiment may determine if the user is driving, participating in a sport, shopping, or the like.

In one embodiment a context associated with a user may include a reading level or comprehension level of the user. The reading or comprehension level of the user may provide an indication of particular words or phrases that the user prefers to use. Additionally, the reading and/or comprehension level may identify a particular style of the user. For example, a user may prefer to use fully spelled out words rather than abbreviations. As another example, a user may prefer a particular synonym of a word over a different synonym of the same word. Determining a reading level or comprehension level may include accessing one or more previous communications or other text or audio based inputs of the user. Using known reading or comprehension level assessment techniques, an embodiment may analyze the communications or inputs to determine an estimated reading or comprehension level of the user.

The reading level and/or comprehension level of the user may also be provided to or assessed by an embodiment. For example, an embodiment may include a reading level or comprehension level test that a user may perform. As another example, one or more devices or data storage locations may include information related to a user's reading or comprehension level. This information may be provided to or accessed by an embodiment to determine the reading or comprehension level of the user. The reading or comprehension level may also be associated with a particular contact of the user. For example, when a user is communicating with a particular contact the user may use a different reading or comprehension level.

Identifying the context of the user may include using one or more sensors of one or more information handling devices. The sensor may be integral to or operatively coupled to one or more information handling devices, including the device receiving the user input and identifying the context of the user. Example sensors may include position sensors (e.g., GPS sensors, location sensors, etc.), image capture sensors or devices (e.g., video camera, still camera, infrared camera, etc.), audio capture sensors or devices (e.g., microphone, vibration detector, etc.), electromyography sensors, and the like. For example, an embodiment may capture images of the environment surrounding the user and parse the image to identify prominent features or identifying features to determine the location of a user. As another example, an embodiment may capture audio and parse the audio to determine who the user may be talking to. As a further example, an embodiment may access location information and determine the country or region that a user is currently located in. These examples are not intended to be limiting as other examples are contemplated and possible as could be understood by one skilled in the art.

Identifying the context information may also include accessing one or more applications or data storage locations of the user. These applications or data storage locations may be mined to identify a context of the user. For example, previous communications may be accessed and analyzed to determine a reading level associated with the user or a contact of the user. As another example, an embodiment may access a calendar of the user to determine an expected location of the user. The calendar entry may also be used to identify an expected activity of the user. As another example, an embodiment may access an email or social media account of the user to determine a reading level of a user. As another example, an embodiment may access settings of an application or device to determine the preferred language and time zone of a user and then use this information to infer a country or region of the user.

The context of the user may be identified using one or a combination of the techniques described above or other similar techniques that can be understood by one skilled in the art. For example, one embodiment may determine the location of the user and then access at least one social media account either associated with the user or location of the user and determine one or more local trends. As an example, an embodiment may determine that a user is in Germany and may access a social media account associated with Germany, for example, a user from Germany, a user currently in Germany, an article based in Germany, a reference to Germany, or the like, and determine that one local trend is a victory in the World Cup Soccer event. Accordingly, an embodiment may determine the context of the user as being in or associated with a country where a major topic of conversation is winning the World Cup.

If a context associated with the user cannot be identified as 302, an embodiment may provide a text suggestion using conventional techniques, for example, only using the user input, using a context of the user input, or the like at 304. If, however, a context associated with the user can be identified at 302, an embodiment may provide a text suggestion based upon not only the one or more characters of the user input, but also on the identified context of the user at 303. Providing one or more text suggestion may include providing a predicted character string based upon a partially received character string. For example, an embodiment may provide a prediction for completion of the character string. Alternatively, providing a text suggestion may include providing a suggested correction of a character string. For example, if an embodiment determines that a character string is misspelled or unrecognized, an embodiment may provide one or more suggestions for correcting the character string.

Providing the text suggestion may include modifying a language model based upon the identified context. For example, conventional text suggestion techniques use a general language model to provide text suggestions based upon the one or more characters received in the user input. Using the systems and methods as described herein, the general language model may be modified or adapted based upon the context of the user. Alternatively, a completely different language model may be selected based upon the context associated with the user. The language model may be unique to the user based upon the context, for example, locally stored on the user's device and then modified or accessed based upon the context of the user. Alternatively, the language model may be a language model that has been modified and stored in a data storage location with other language models that may be accessible by many different devices and users. Upon identifying the context of the user, an embodiment may then access the appropriate language model from the database or library of language models.

Provision of the text suggestion may include modifying text suggestions or a ranking of text suggestions based upon the identified context of the user. For example, if a user provides the input “th” the top rated suggestion, without knowing the context of the user, may be the word “the”. However, using the techniques as described herein, if an embodiment has determined the user is at the theatre, the top rated suggestion may be modified to “theatre” rather than “the”. In other words, the context may be used to promote one or more text suggestions over other text suggestions. As another example, an embodiment may determine that a user is currently watching a basketball game and may promote text suggestions associated with basketball higher than other, including standard, text suggestions. As another example, using the World Cup example discussed above, an embodiment may promote text suggestions associated with winning the World Cup. As a final example, an embodiment may promote or provide text suggestions based upon the reading or comprehension level of the user. For example, if a user typically uses long, complicated, or obscure words, rather than shorter, simpler, or more common words, an embodiment may provide long, complicated, or obscure words as text suggestions as opposed to the shorter, simpler, or more common words. As stated before, these examples are merely intended to provide context and are not intended to be limiting in any way.

The various embodiments described herein thus represent a technical improvement to conventional text suggestions system. Rather than only relying on standard language models or context of the text input only, the systems and methods as described herein use an identified user context to provide text suggestions which may be more closely related to what the user is attempting to provide as text input. Accordingly, the user does not have to sort through different suggestions which may not be applicable or, alternatively, provide additional input in order to get a text suggestion that is the desired character string. Such techniques enable a more intuitive text suggestion system that is more efficient and less cumbersome for a user.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, from a user, user input comprising one or more characters;
identifying, using a processor, a context associated with the user; and
providing, using a processor, at least one text suggestion based upon the received one or more characters and the identified context.

2. The method of claim 1, wherein the identifying a context associated with the user comprises identifying a reading level of the user.

3. The method of claim 2, wherein the receiving user input comprises receiving user input for a communication of the user to another user and wherein identifying a context associated with the user comprises identifying a reading level of the user in relation to communications with the another user.

4. The method of claim 1, wherein the identifying a context associated with the user comprises identifying a location of the user.

5. The method of claim 4, wherein the identifying a context associated with the user comprises accessing at least one social media account and determining a trend from the at least one social media account associated with the identified location.

6. The method of claim 1, wherein the providing a text suggestion comprises modifying a language model based upon the received one or more characters and the identified context.

7. The method of claim 1, wherein the providing a text suggestion comprises providing a correction to the one or more characters.

8. The method of claim 1, wherein the providing a text suggestion comprises providing a predicted character string.

9. The method of claim 1, wherein the providing a text suggestion comprises providing a plurality of text suggestions.

10. The method of claim 9, wherein the providing a text suggestion further comprises promoting at least one of the plurality of text suggestions based upon the identified context.

11. An information handling device, comprising:
a processor;
a memory device that stores instructions executable by the processor to:
receive, from a user, user input comprising one or more characters;
identify a context associated with the user; and
provide at least one text suggestion based upon the received one or more characters and the identified context.

12. The information handling device of claim 11, wherein the instructions executable by the processor to identify a context associated with the user comprise instructions executable by the processor to identify a reading level of the user.

13. The information handling device of claim 12, wherein the instructions executable by the processor to receive user input comprise instructions executable by the processor to receive user input for a communication of the user to another user and wherein the instructions executable by the processor to identify a context associated with the user comprise instructions executable by the processor to identify a reading level of the user in relation to communications with the another user.

14. The information handling device of claim 11, wherein the instructions executable by the processor to identify a context associated with the user comprise instructions executable by the processor to identify a location of the user.

15. The information handling device of claim 14, wherein the instructions executable by the processor to identify a context associated with the user comprise instructions executable by the processor to access at least one social media account and to determine a trend from the at least one social media account associated with the identified location.

16. The information handling device of claim 11, wherein the instructions executable by the processor to provide a text suggestion comprise instructions executable by the processor to modify a language model based upon the received one or more characters and the identified context.

17. The information handling device of claim 11, wherein the instructions executable by the processor to provide a text suggestion comprise instructions executable by the processor to provide a correction to the one or more characters.

18. The information handling device of claim 11, wherein the instructions executable by the processor to provide a text suggestion comprise instructions executable by the processor to provide a predicted character string.

19. The information handling device of claim 11, wherein the instructions executable by the processor to provide a text suggestion comprise instructions executable by the processor to provide a plurality of text suggestions and to promote at least one of the plurality of text suggestions based upon the identified context.

20. A product, comprising:
a storage device that stores code, the code being executable by a processor and comprising:
code that receives, from a user, user input comprising one or more characters;
code that identifies a context associated with the user; and
code that provides at least one text suggestion based upon the received one or more characters and the identified context.
